(19) United States
(12) Patent Application Publication
(10) Pub. No.: US 2011/0239121 A1
(43) Pub. Date: Sep. 29, 2011

(54) INFORMATION PROCESSING APPARATUS, INFORMATION PROCESSING SYSTEM, INFORMATION PROCESSING METHOD, AND COMPUTER READABLE MEDIUM STORING INFORMATION PROCESSING PROGRAM

(75) Inventor: Masahiro YAMADA, Yokohama-shi (JP)

(73) Assignee: FUJI XEROX CO., LTD., Tokyo (JP)

(21) Appl. No.: 12/858,079

(22) Filed: Aug. 17, 2010

(30) Foreign Application Priority Data
Mar. 25, 2010 (JP) 2010-070716

(51) Int. Cl. G06F 3/048; G06F 15/16

(52) U.S. Cl. 715/733

(57) ABSTRACT

The present invention provides an information processing apparatus including: an acquisition section that acquires first display content information indicating display content being displayed at a display section of a device used by a user, and user information indicating the user that displayed the display content at the display section; a generating section that, when second display content information corresponding to the user information acquired by the acquisition section is stored in a storage section, generates difference information indicating a difference between the stored second display content information and the acquired first display content information being displayed at the display section; and a transmission section that transmits a display instruction to display the difference information at the display section of the device.

### CROSS-REFERENCE TO RELATED APPLICATION

This application is based on and claims priority under 35 USC 119 from Japanese Patent Application No. 2010-070716 filed Mar. 25, 2010

### BACKGROUND

### Technical Field

The present invention relates to an information processing apparatus, an information processing system, an information processing method, and a computer readable medium storing an information processing program.

### SUMMARY

According to a first aspect of the invention, there is provided a information processing apparatus including: an acquisition section that acquires first display content information indicating display content being displayed at a display section of a device used by a user, and user information indicating the user that displayed the display content at the display section; a generating section that, when second display content information corresponding to the user information acquired by the acquisition section is stored in a storage section, generates difference information indicating a difference between the stored second display content information and the acquired first display content information being displayed at the display section; and a transmission section that transmits a display instruction to display the difference information at the display section of the device.

### BRIEF DESCRIPTION OF THE DRAWINGS

Exemplary embodiments of the present invention will be described in detail based on the following figures, wherein:

FIG. 1 is a schematic configuration diagram of an example of a schematic configuration of an information processing system according to the present exemplary embodiment;

FIG. 2 is a functional block diagram showing an example of a schematic configuration of a client device according to the present exemplary embodiment;

FIG. 3 is a table showing an example of tags indicating screens subject to display content change recognition according to the present exemplary embodiment;

FIG. 4 is a functional block diagram showing an example of a schematic configuration of a user administration device according to the present exemplary embodiment;

FIG. 5 is a functional block diagram showing an example of a schematic configuration of an information processing apparatus according to the present exemplary embodiment;

FIG. 6 is a flow chart showing an example of processing executed by a controller of a client device according to the present exemplary embodiment;

FIG. 7 is a diagram for explaining an example of a screen subject to display content change recognition (post-change screen) being displayed on a user I/F of a client device according to the present exemplary embodiment;

FIG. 8 is a flow chart showing an example of processing executed by a controller of an information processing apparatus according to the present exemplary embodiment;

FIG. 9 is a diagram for explaining an example of a display content administration table stored in a display content administration table storage section of an information processing apparatus according to the present exemplary embodiment;

FIG. 10 is a diagram for explaining an example of display content already stored in a display content storage section of an information processing apparatus according to the present exemplary embodiment;

FIG. 11 is a diagram for explaining an example of latest display content stored in a latest display content storage section of an information processing apparatus according to the present exemplary embodiment;

FIG. 12 is a diagram for explaining an example of display content in which generated difference information is reflected by a display content generation section of a information processing apparatus according to the present exemplary embodiment;

FIG. 13 is a diagram for explaining an example of a pre-change screen corresponding to the example of a post-change screen shown in FIG. 7;

FIG. 14 is a diagram for explaining an example of a difference information display screen in which difference information between the post-change screen shown in FIG. 7 and the pre-change screen shown in FIG. 13 is displayed;

FIG. 15 is a diagram for explaining an example of a difference information display screen shown in FIG. 14; and

FIG. 16 is a diagram for explaining an example of a difference information display screen of an e-mail list showing the state of transmission and reception of e-mail displayed on a user I/F of a client device according to a present exemplary embodiment.

### DETAILED DESCRIPTION

Herebelow, an example of an exemplary embodiment of the present invention will be described in detail with reference to the drawings.

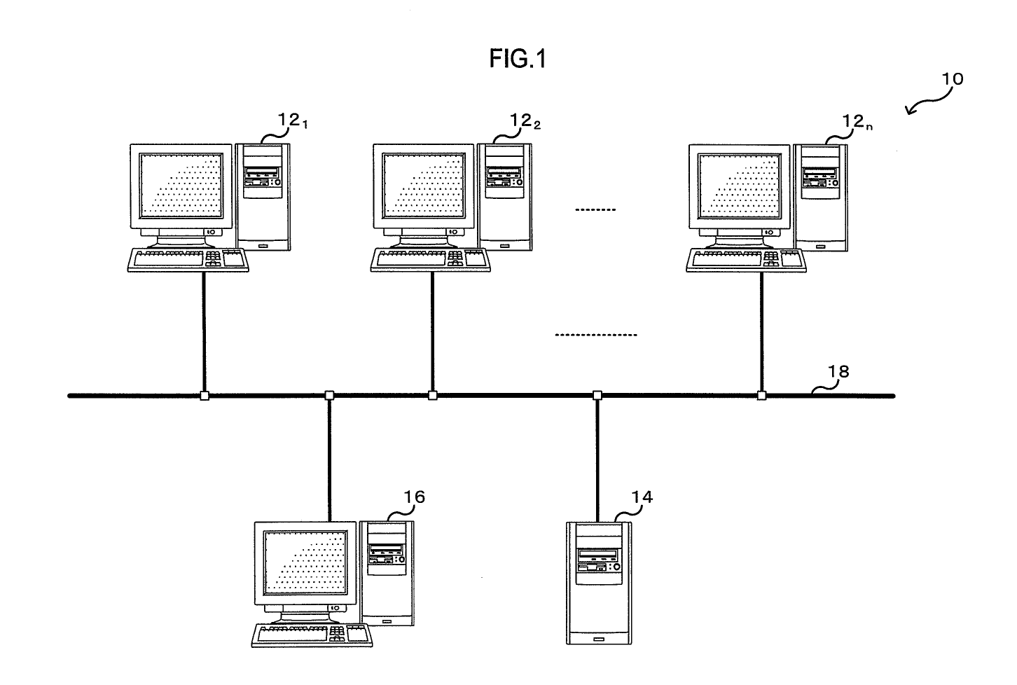

FIG. 1 is a schematic diagram showing a schematic configuration of an example of an information processing system of the present exemplary embodiment. An information processing system 10 is configured to include: client devices 12₁ to 12ₙ; a user administration device 14; and an information processing apparatus 16. The client devices 12, the user administration device 14, and the information processing apparatus 16, transmit and receive signals between each other, for example, via a web communication line 18. In the present exemplary embodiment, explanation follows regarding the information processing system 10 in a case of a web-based system, using the web communication line 18. However, the present invention is not limited thereto, and the information processing system may be configured with connections using another type of communication line 18. Explanation follows regarding the present exemplary embodiment for a case in which the information processing apparatus 16 is a print server.

The information processing system 10 of the present exemplary embodiment is configured with an individual client devices 12. Accordingly, when there is no need to discriminate between the individual client devices, the individual reference number of the devices is not appended, and reference is simply made to “client devices 12”. FIG. 1 illustrates client devices 12 that are the same type of computer device. However, the present invention is not limited thereto. For example, the client device 12 may be an image forming apparatus, such as, for example, a printer, or various types of terminal device, and any user-employed device may be configured without particular limitation. There is also no particular limitation regarding the number of client devices 12.

In the information processing system 10 of the present exemplary embodiment, information indicating the difference between display content a user is displaying on a display section and display content previously displayed to the same user (this may be the display content displayed on a client device 12 different to the client device 12 currently employed by the user) is generated by the information processing apparatus 16. Next, the information processing system 10 transmits to the client device 12 information reflecting this difference information in the display content being displayed, and displays the display content thereon.

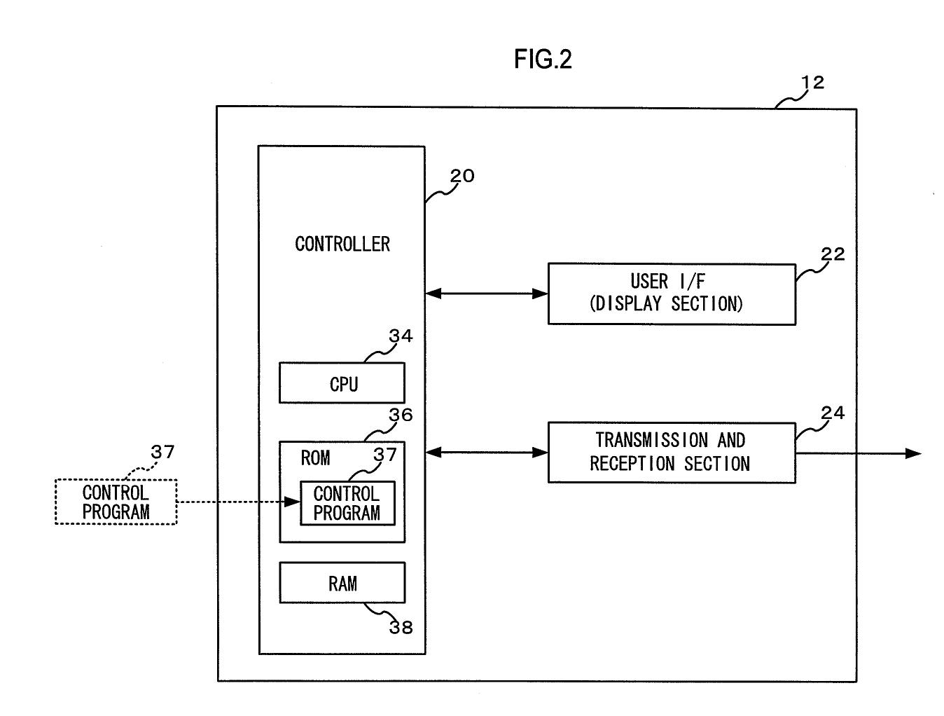

First, explanation will be given regarding a schematic configuration of the client device 12 of the present exemplary embodiment. FIG. 2 is a functional block diagram showing an example of a schematic configuration of the client device 12. The client device 12 of the present exemplary embodiment is configured to include a controller 20, a user interface (I/F) 22, and a transmission and reception section 24.

The controller 20 performs overall control of the client device 12. The controller 20 is configured to include a CPU 34, ROM 36, and RAM 38. A control program 37 for control, executed by the CPU 34, is stored on the ROM 36. In the present exemplary embodiment configuration is made with the control program 37 pre-stored. However, the present invention is not limited thereto. For example, the control program 37 may be stored on a storage medium, such as, for example, a CD-ROM or a removable disk, and installed from the recording medium onto the controller 20. Alternatively, the control program 37 may, for example, be installed in the controller 20 from an external device, via a communications line, such as, for example, the Internet. The RAM 38 secures a working space for when the control program 37 is executed by the CPU 34.

The user I/F 22 of the present exemplary embodiment includes at least a display section, such as a display or the like. The user I/F 22 acquires information indicating user instructions from the information processing apparatus 16, and displays this information on a screen. The transmission and reception section 24 transmits and receives various types of information with the user administration device 14 and the information processing apparatus 16. Specifically, the user I/F 22 of the present exemplary embodiment is a web browser.

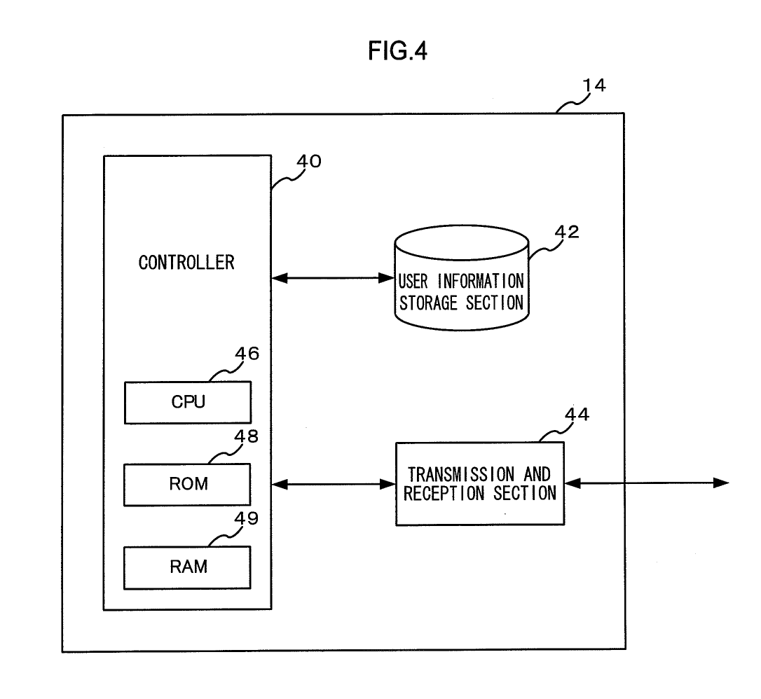

Next, explanation follows regarding a schematic configuration of the user administration device 14 of the present exemplary embodiment. FIG. 4 is a functional block diagram showing an example of a schematic configuration of the user administration device 14. The user administration device 14 of the present exemplary embodiment is configured including a controller 40, a user information storage section 42 and a transmission and reception section 44.

The controller 40 performs overall control of the user administration device 14. The controller 40 is configured including a CPU 46, ROM 48, and RAM 49. A control program for control, executed by the CPU 46, is stored on the ROM 48. The RAM 49 secures a working space for when the control program is executed by the CPU 46.

The user information storage section 42 stores user information. In the user information storage section 42 of the present exemplary embodiment, information data base for user administration is stored in advance, and the user information storage section 42 performs administration of the client device 12 users.

The transmission and reception section 44 transmits and receives various information with the client device 12 and the information processing apparatus 16.

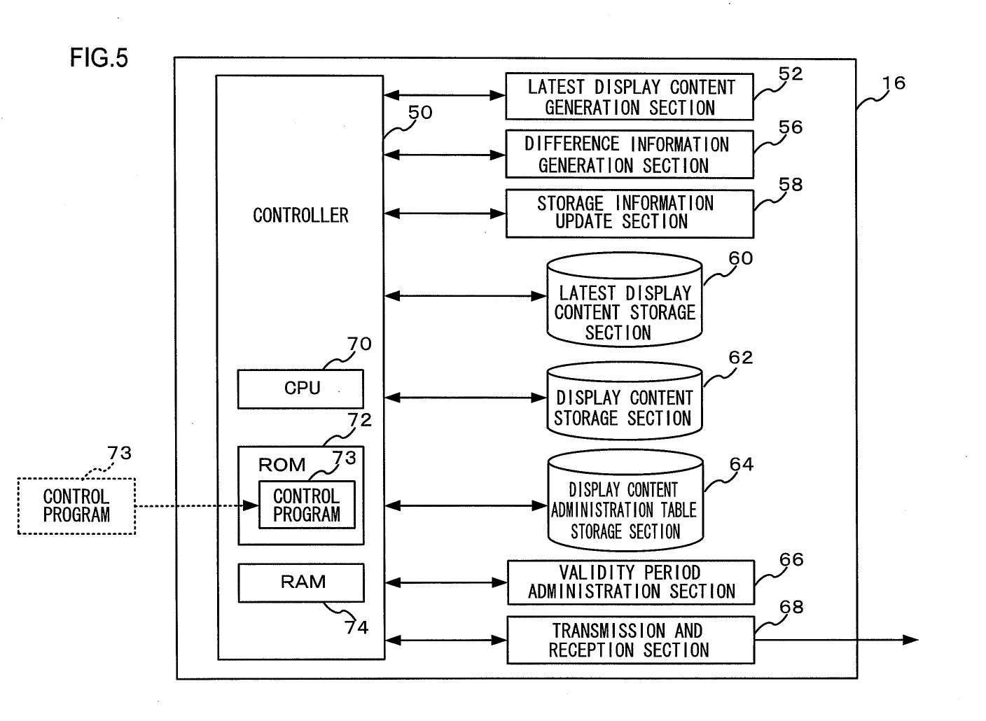

Further explanation follows regarding a schematic configuration of the information processing apparatus 16 of the present exemplary embodiment. FIG. 5 is a functional block diagram showing an example of a schematic configuration of the information processing apparatus 16. The information processing apparatus 16 of the present exemplary embodiment is configured including a controller 50, a latest display content generation section 52, a difference information generation section 56, a storage information update section 58, a latest display content storage section 60, a display content storage section 62, a display content administration table storage section 64, a validity period administration section 66 and a transmission and reception section 68.

The controller 50 performs overall control of the information processing apparatus 16. The controller 50 is configured to include a CPU 70, ROM 72, and RAM 74. A control program 73 for control, executed by the CPU 70, is stored on the ROM 72. The control program 73 in the present exemplary embodiment is pre-stored. However, the present invention is not limited thereto. The control program 73 may, for example, be stored on a recording medium such as, for example a CD-ROM, a removable disk or the like, and installed to the controller 50 from the recording medium. The control program 73 may also be installed to the controller 50 from an external device, via a communications line, such as the Internet. The RAM 74 secures a working space for when the control program 73 is executed by the CPU 70.

When, by a user of the client device 12 accessing the URL of the print job screen, an instruction to display a print job screen is received, the latest display content generation section 52 generates the print job screen in its latest state (latest display content).

The difference information generation section 56 generates difference information relating to the difference between information received from the client device 12 indicating the display content being displayed on the user I/F 22 (information temporarily stored on the latest display content storage section 60 indicating the latest display content), and information stored in the display content storage section 62.

The storage information update section 58 updates various types of information stored on the latest display content storage section 60, the display content storage section 62, and the display content administration table storage section 64.

The latest display content storage section 60 stores in a data base the latest display content generated by the latest display content generation section 52. The display content storage section 62 stores, for example, the display content and the like, in a data base. The display content administration table storage section 64 stores a display content administration table in a data base. The display content administration table associates and administers the display content stored in the display content storage section 62, the information indicating the user who displayed that particular display content on the user I/F 22 of the client device 12, and a validity period of that particular display content.

The validity period administration section 66 administers the display content stored in the display content storage section 62. The validity period administration section 66 references the display content administration table storage section 64 at a predetermined timing or periodically, and deletes any display content that has expired its validity period from the display content storage section 62. In the present exemplary embodiment, the validity period is preset according to the type (characteristics) of the display content (described in detail below), however there is no limitation thereto, and the validity period may be set by a user.

The transmission and reception section 68 transmits and receives various information to and from the client device 12 and the user administration device 14.

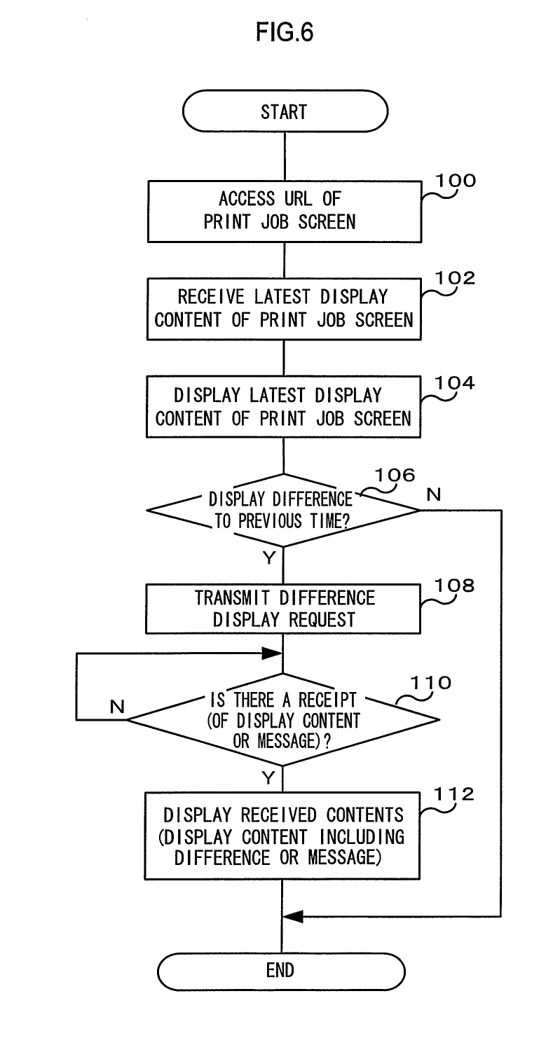

Explanation follows regarding the operation of the information processing system 10 of the present exemplary embodiment. First explanation follows regarding the operation of the client device 12. FIG. 6 is a flow chart showing an example of control processing executed by the controller 20 of the client device 12 of the present exemplary embodiment. The information processing system 10 of the present exemplary embodiment executes the current processing only when user validation has been performed by the user administration device 14.

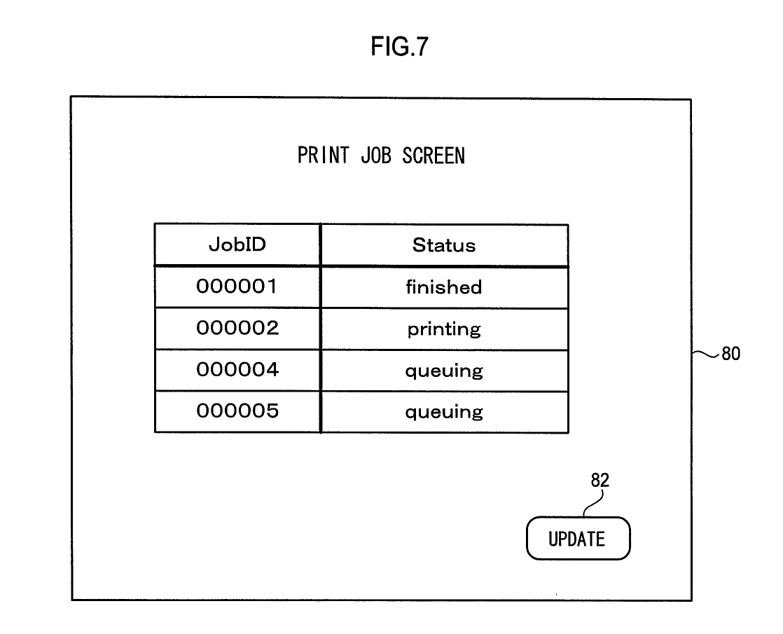

At step 100, a user accesses the URL of a print job screen with the user I/F 22. At step 102, accompanying the above access, the controller 20 receives the latest display content of the print job screen from the information processing apparatus 16. At the next step 104, the controller 20 displays the received latest display content print job screen on the user I/F 22. An example of the latest display content print job screen is shown in FIG. 7.

FIG. 7 shows a case of the above described latest display content print job screen, as a print job screen 80. Note that, an update button 82 is displayed on the print job screen 80, in addition to usual contents showing the state of progress of print jobs.

In the next step 106, the controller 20 determines whether to display the differences to the print job screen displayed the previous time. In the present exemplary embodiment, determination is made as to whether the update button 82 has been “pressed”. When the update button 82 has been “pressed” by a user, affirmative determination is made and the processing proceeds to step 108. However, the controller 20 makes negative determination when a predetermined duration elapses without the update button 82 being “pressed”, or when a user has instructed display of another screen on the user I/F 22, and the current processing is ended.

In step 108, the controller 20 transmits a difference display request, to display the differences to the previous time, to the information processing apparatus 16.

At the next step 110, the controller 20 determines whether the transmission and reception section 24 has received the display content or a message (described in detail below) from the information processing apparatus 16. When not yet received, the controller 20 makes negative determination, and a standby state is adopted. However, when received, affirmative determination is made, and processing proceeds to step 112.

At step 112, the controller 20 ends the current processing after the display content or the message received from the information processing apparatus 16 has been displayed. In cases when there is a difference between the display content displayed to the user the previous time and the display content being currently displayed, the controller 20 displays information indicating the display content in which the difference is reflected (described in detail below) on the screen of the user I/F 22.

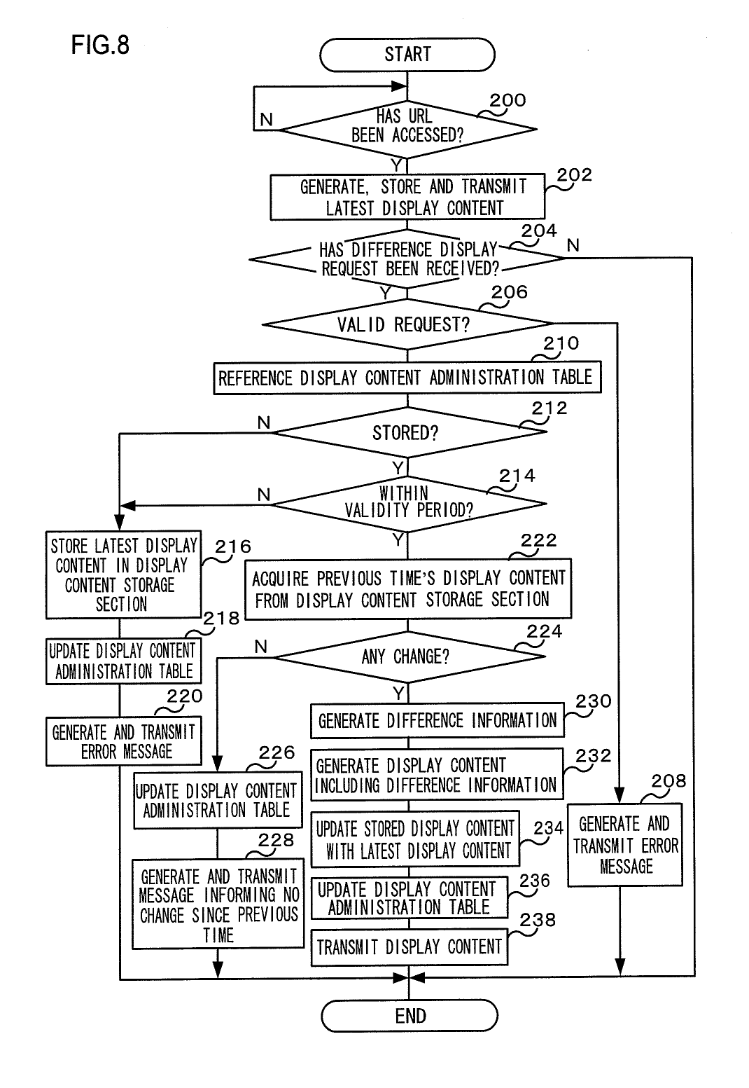

Next, explanation follows regarding operation of the information processing apparatus 16 of the present exemplary embodiment. FIG. 8 is a flow chart showing an example of control processing executed by the controller 50 in the information processing apparatus 16 of the present exemplary embodiment.

In step 200, the controller 50 determines whether the client device 12 has accessed the URL of the print job screen through the transmission and reception section 68. The controller 50 makes negative determination when not accessed, and a standby state is adopted. However, when accessed, the controller 50 makes affirmative determination, and the processing proceeds to step 202.

At step 202, in response to the access, the controller 50 generates the latest state of the print job screen, stores this in the latest display content storage section 60, and transmits to the client device 12. At the next step 204, the controller 50 determines whether a difference display request has been received. When, for example, a specific duration has elapsed without receipt thereof, or the like, the controller 50 makes negative determination and the current processing is ended. However, when received, affirmative determination is made, and the processing proceeds to step 206. At step 206, the controller 50 determines whether the received request is a valid request. In the present exemplary embodiment, determination is made of the validity of the request by interrogating a user administration device and determining whether the user making the request is a bona fide user, and whether the instructed print job screen is a screen subject to display content change recognition. When the user is bone fide, and the screen is subject to display content change recognition, the controller 50 determines that the request is valid, and the processing proceeds to step 210.

However, when the request is not valid, the controller 50 makes a negative determination, the processing proceeds to step 208, the controller 50 generates an error message, such as, for example, information to inform that the screen is not subject to display content change recognition, transmits the error message so as to be displayed on the user I/F 22 of the client device 12, and ends the current processing.

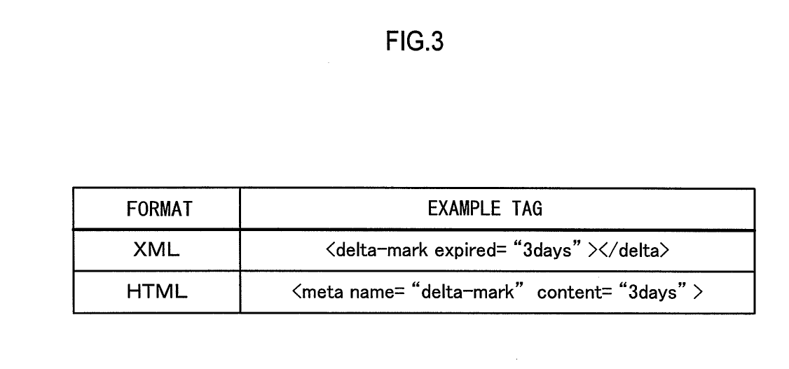

Note that, “the screen subject to display content change recognition” for which it is easy to recognize the difference between the display content displayed to the user on the user I/F 22 the previous time, and the contents currently displayed. Accordingly, the screen subject to display content change recognition represents changes of the display contents with the passage of time. Examples of screens subject to display content change recognition include, for example: print job screens indicating the state of printing instructed to an image forming apparatus (printer) or the like; e-mail lists indicating information of the state of newly delivered e-mail, unread/read e-mail; and the like. Which display contents are screens that are subject to display content change recognition is stored in advance in the information processing system 10. As an example, since the present exemplary embodiment is applied to a web based system, a predetermined tag is inserted in advance in the markup language, such as, for example, in XML or HTML format indicating the screen for display in the system, and screens with this tag are treated as screens subject to display content change recognition. Therefore, information indicating this tag is stored in advance in the information processing system 10. Specific examples in the present exemplary embodiment of such a tag are shown in FIG. 3. In FIG. 3, an example is shown of a case where the tag includes information indicating the validity period of the screen (display content).

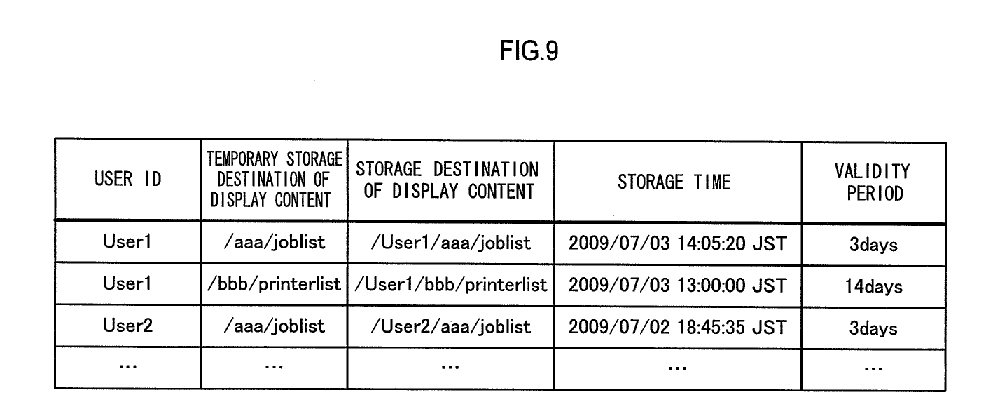

At the next step 210, the controller 50 refers to a display content administration table stored in the display content administration table storage section 64. An example of a display content administration table of the present exemplary embodiment is shown in FIG. 9. The display content administration table is one in which the following are associated with each other: user ID; storage destination (address or the like) of the latest display content in the latest display content storage section 60; storage destination (address or the like) of the display content in the display content storage section 62; storage time; and validity period. The user ID is information indicating the user. The storage time is the time when the display content was stored in the display content storage section 62. The validity period is a validity period of the display content stored on the display content storage section 62.

At the next step 212, the controller 50 references the display content administration table stored in the display content administration table storage section 64, and determines whether the received display content is already stored in association with the received user ID. If not stored, the controller 50 makes negative determination, and the processing proceeds to step 216.

However, when already stored, the controller 50 makes affirmative determination, and the processing proceeds to step 214. At step 214, the controller 50 determines whether the stored contents stored in the display content storage section 62 is within its validity period. When the validity period has expired, the controller 50 makes negative determination, and the processing proceeds to step 216.

At step 216, the latest display content stored in the latest display content storage section 60 is stored in the display content storage section 62. At the next step 218, the display content administration table stored in the display content administration table storage section 64 is updated. At the next step 220, the controller 50 generates a predetermined error message, and ends the current processing after transmitting the error message to the client device 12. When the validity period has expired, the controller 50 deletes the data that has expired its validity period, and the new data is stored in the display content administration table. Or, when there is a new storage time and storage destination for the updated data for the information that has expired its validity period, the changed storage destination is updated.

However, when determined to be within the validity period, the controller 50 makes affirmative determination and the processing proceeds to step 222.

At step 222, the controller 50 acquires information indicating the display content already stored, from the display content storage section 62. At the next step 224, the controller 50 compares this information with the latest display content stored in the latest display content storage section 60, and the controller 50 determines whether there has been a change. When there has been no change, the controller 50 makes negative determination and the processing proceeds to step 226. At step 226, the controller 50 updates the display content administration table. Then, at the next step 228, a message informing that there is no difference to the previous time is generated and transmitted to the client device 12. The controller 50 then ends the current processing.

However, when there has been a change, the processing proceeds to step 230, and difference information is generated by the difference information generation section 56. At the next step 232, information is generated indicating the display content in which the generated difference information is reflected.

In the present exemplary embodiment, explanation is given of an example in which difference information is generated by the difference information generation section 56, followed by processing to generate information indicating the display content in which the difference information is reflected. The present exemplary embodiment is applied to a web based system. Consequently, the information indicating the display content is text data, expressed in a markup language, such as, for example, HTML, XML, or the like. Therefore, the difference information is extracted using a commonly used command employed for comparison, such as, for example, a diff program command. This is readily performed by data manipulation (generating difference information, output etc.) using, for example, a DOM or SAX technique when the display content information is XML format data, or using an XSL technique when in a web display language such as HTML format.

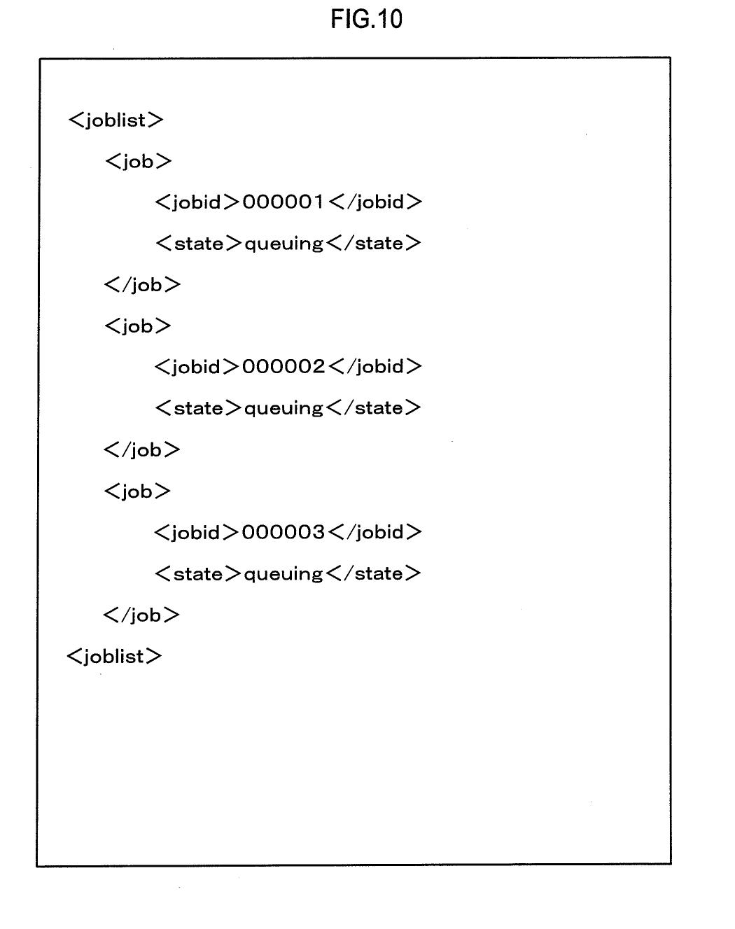

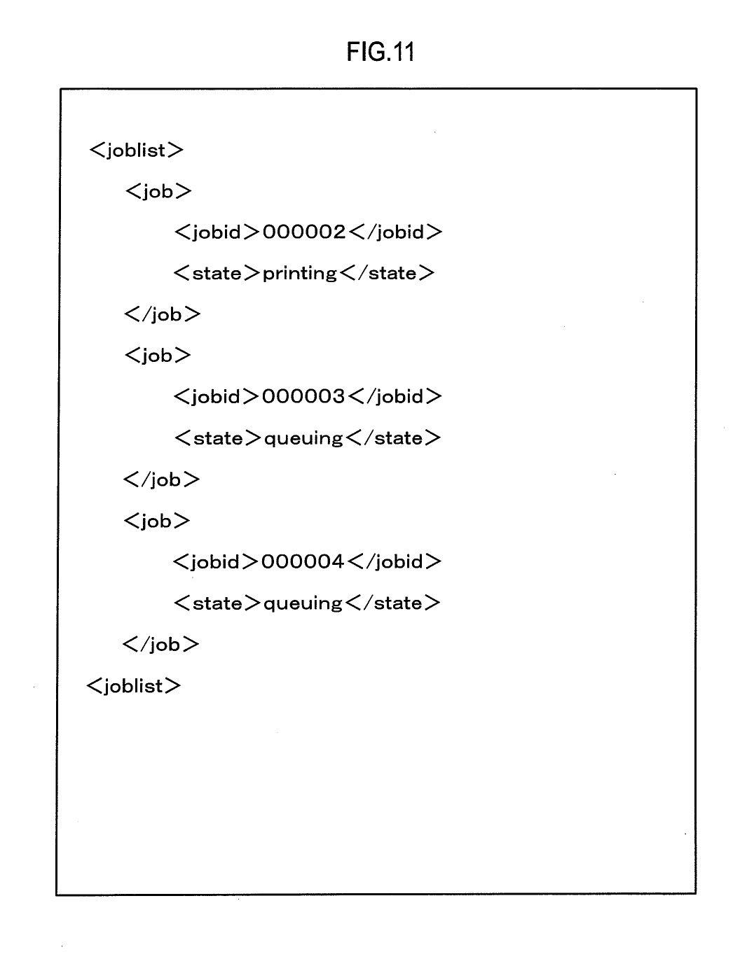

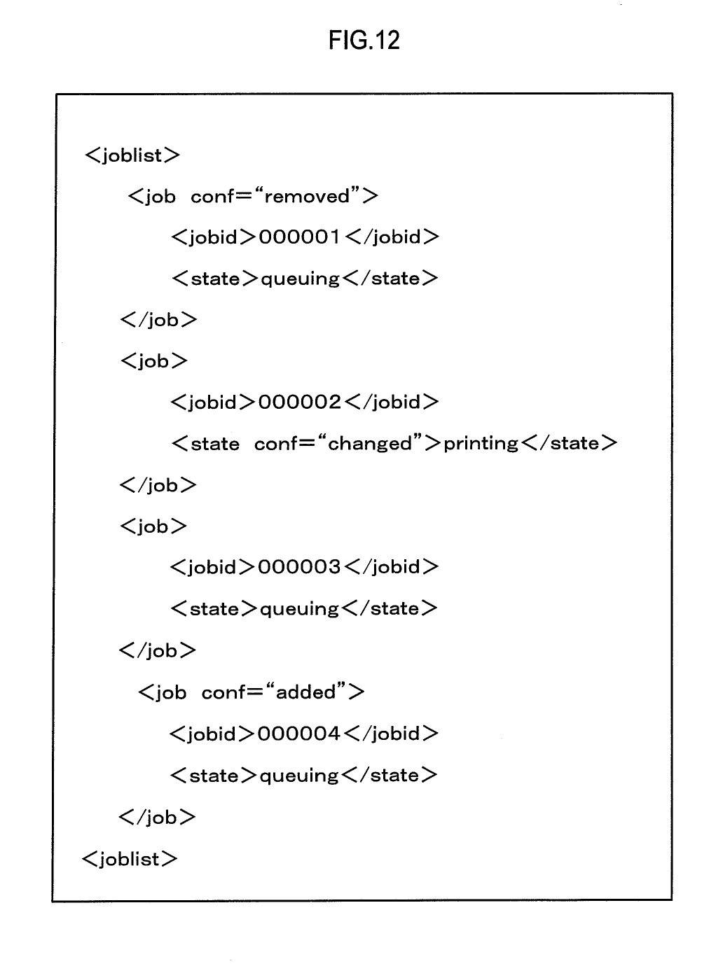

As an example is given of a case with XML format data, the display content already stored in the display content storage section 62, the display content received from the client device 12 (this being the display content being displayed on the user I/F 22, the latest display content stored in the latest display content storage section 60), and the display content reflecting the difference information generated by a display content generation section 54. An example of display content already stored in the display content storage section 62 is shown in FIG. 10. Further, an example of latest display content stored in the latest display content storage section 60 is shown in FIG. 11. Furthermore, an example of display content reflecting difference information is shown in FIG. 12.

In the next step 234, the display content stored in the display content storage section 62 is updated, from the display content already stored therein to the latest display content stored in the latest display content storage section 60. In the present exemplary embodiment, the latest display content stored is deleted in the latest display content storage section 60 after updating.

At the next step 236, the controller 50 updates the display content administration table stored in the display content administration table storage section 64.

At the next step 238, screen information, indicating the display content including the generated difference information, is generated by the latest display content generation section 52, is transmitted to the client device 12 using the transmission and reception section 68, and is instructed to be displayed. The current processing is then ended.

According to the current processing, the display content reflecting the difference information to the previous time of display is displayed on the screen of the user I/F 22 of the client device 12. Next, explanation follows regarding an example of display content in which the difference information is reflected.

In the present exemplary embodiment, since the difference information is displayed on the user I/F 22, the difference information is visibly represented by, for example, by making a different color, font, size or the like of text, animating the text, or the like using, for example, style sheet technology of HTML format. There is, however, no limitation thereto, and the difference information may be represented audible, such as by sound or the like.

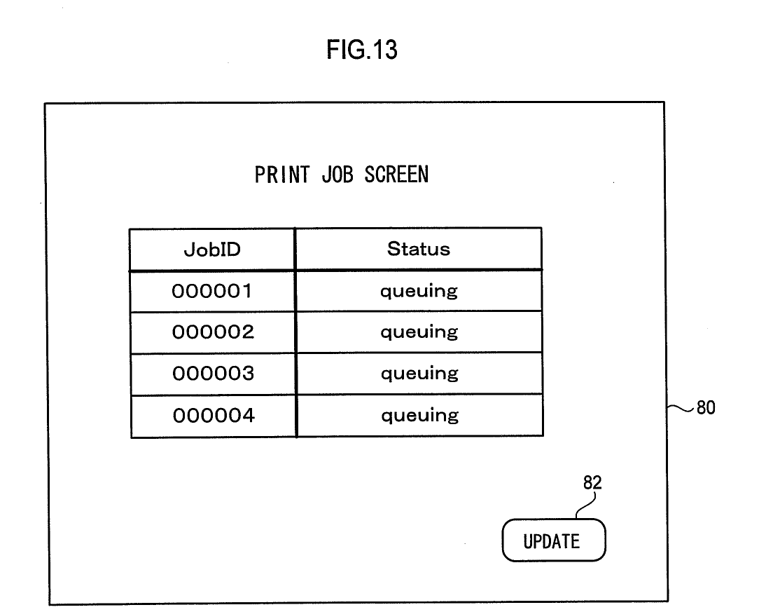

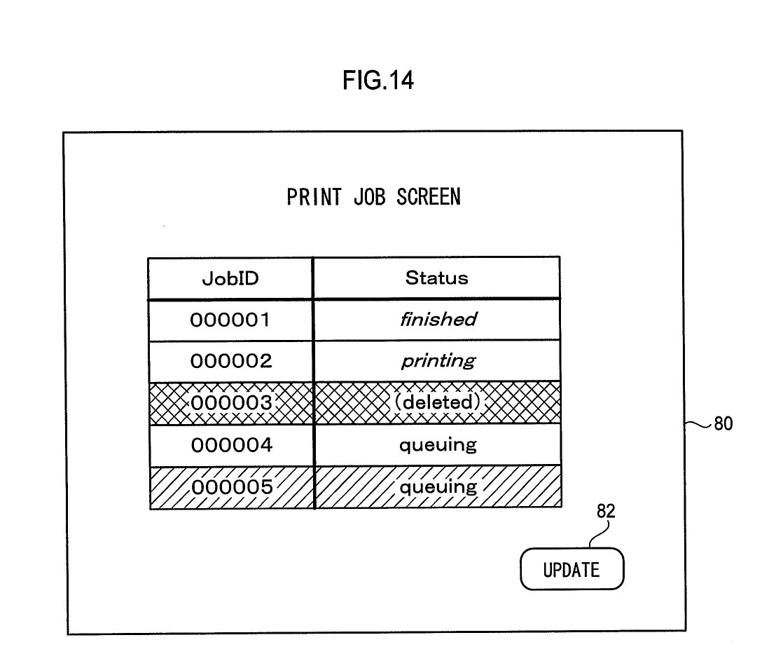

FIG. 13 shows an example of a screen of the display content already stored in the display content storage section 62 (referred to below as the pre-change screen), corresponding to the display content screen subject to display content change recognition of FIG. 7 (referred to below as post-change screen). FIG. 14 shows an example of a screen in which difference information, generated by the information processing apparatus 16, between the post-change screen and pre-change screen displayed on the user I/F 22 of the client device 12 (referred to below as the difference information display screen), is expressed. In the difference information display screen shown in FIG. 14, the font of the changed value text in the “Status” column has been made different from other text (see Job ID 000001 and 000002). Further, text that has been deleted in the post-change screen is shown by diamond-hash shading, showing that it has been deleted (see Job ID 000003). Furthermore, additions in the post-change screen are shown by diagonal shading (see Job ID 000005).

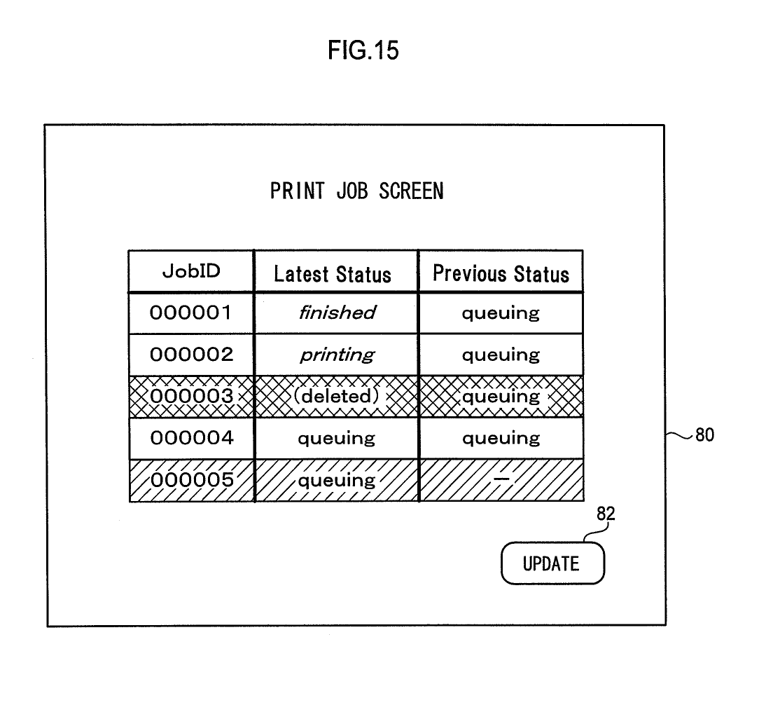

In the present exemplary embodiment, a difference information display screen is displayed, in which the differences between the pre-change screen and the post-change screen are reflected is this manner. However, there is no limitation thereto, and configuration may be made with other representations. For example, while an example has been given of the display content of the pre-change screen and the display content of the post-change screen both shown on the same screen, the differences therebetween may be displayed as the difference information display screen. Another example of a difference information display screen, corresponding to FIG. 14, is shown in FIG. 15. By displaying “Latest Status” and “Previous Status” together shown as in FIG. 15, a user is made aware of the differences (changes) occurring.

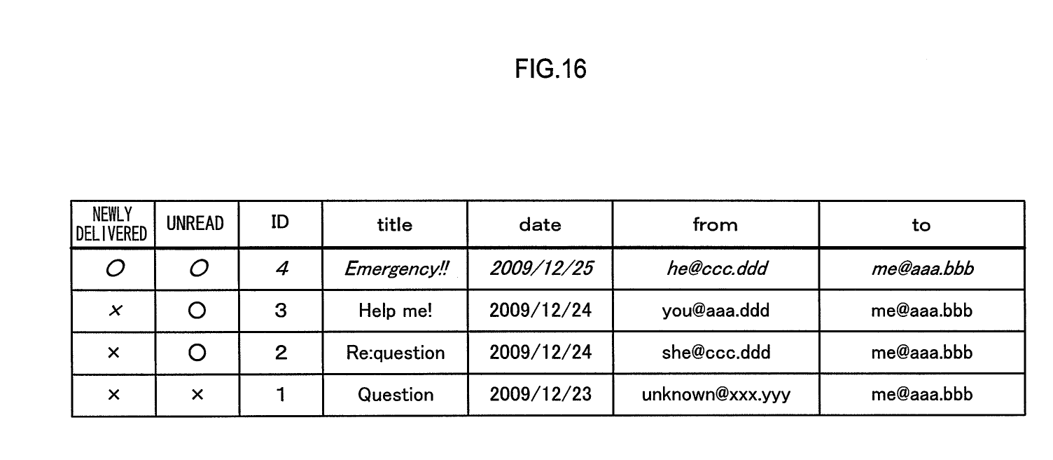

Furthermore, a specific example of a case of the information processing apparatus 16 of the present exemplary embodiment as an e-mail server, in application to e-mail (web e-mail), is shown in FIG. 16. FIG. 16 shows an example of a difference information display screen of an e-mail list. The e-mail list is an example of a tabular display of, for example, the title, transmission time, transmitting person, receiving person and the like of e-mails.

In the specific example shown in FIG. 16, a new delivery flag and an unread flag are used as attributes of the e-mail list. In the e-mail list, changed display content from that viewed the previous time is shown by different character font from the rest of the text. In the ID of the e-mail list, ID=1 indicates an already read e-mail reoccurring from the previous time, ID=2 indicates an unread e-mail reoccurring from the previous time, ID=3 indicates a non-new e-mail that arrived and was unread the previous time, and is still unread the current time, ID=4 indicates an e-mail newly delivered the current time and not yet read. The information processing apparatus 16 of the present exemplary embodiment displays the difference information to the previous viewing is this manner.

In the present exemplary embodiment as described previously, when a user accesses the URL of a print job screen using the user I/F 22, the information processing apparatus 16 generates a print job screen representing the latest state (latest display content), and this is stored in the latest display content storage section 60. Accompanying this, the information processing apparatus 16 displays the print job screen showing the latest state on the client device 12. The client device 12 transmits the difference display request, including information indicating the user (user ID) of the client device 12, to the information processing apparatus 16. When a difference display request is received by the transmission and reception section 68, the information processing apparatus 16 references the display content administration table of the display content administration table storage section 64. Next, the information processing apparatus 16 determines whether there is stored information that corresponds to the received user ID and expresses this display content displayed to the user the previous time. When the information processing apparatus 16 determines that such information is stored, and that this information indicating the display content displayed the previous time is within its validity period, the information processing apparatus 16 compares the display content displayed the previous time and the latest display content. When there has been a change (difference) the information processing apparatus 16 generates difference information using the difference information generation section 56, generates display content in which the difference information is reflected, and transmits this information to be displayed on the client device 12. Accompanying this, the information processing apparatus 16 updates the display content administration table stored in the display content administration table storage section 64. When either there is no display content corresponding to the latest display content stored in the display content storage section 62, or there is corresponding information stored but its validity period has expired, the information processing apparatus 16 stores the latest display content as the display content in the display content storage section 62. Accompanying this, the information processing apparatus 16 updates the display content administration table stored in the display content administration table storage section 64.

Thereby, the information processing apparatus 16 of the present exemplary embodiment can provide to a user difference information irrespective of which client device 12 is being used by the user, even in cases, for example, where the screen subject to display content change recognition is displayed on a user I/F 22 of a different client device to that used previous time.

The information processing apparatus 16 of the present exemplary embodiment associates user IDs and administers information indicating the display content, using the display content administration table storage section 64. Consequently, difference information specific to the user can be provided.

The information processing apparatus 16 of the present exemplary embodiment does not generated difference information when the validity period has expired. Consequently, the information processing apparatus 16 of the present exemplary embodiment does not supply to the client device 12 information determined to be information that has become outdated, where determined that there is no value in displaying difference information to a user.

In the information processing apparatus 16 of the present exemplary embodiment, the validity period administration section 66 administers the validity periods of information indicating the display content. The validity period administration section 66 deletes information indicating display content that has expired its validity period from the display content storage section 62.

The information processing apparatus 16 of the present exemplary embodiment is configured to generate the difference to the display content the previous time, stored in the display content storage section 62. However, the present invention is not limited thereto. In the alternative exemplary embodiment, display content prior to the previous time may be stored in the display content storage section 62, and difference information to the display content prior to the previous time may be generated and displayed. In this alternative exemplary embodiment, transitions in the display content can be displayed to a user.

In the present exemplary embodiment, and difference information is generated by extracting differences in each of the values of character strings in information indicating display content. However the difference information is not limited thereto, and differences in presentation, such as, for example, color, style or the like, may be extracted and generated. Presentation is fundamentally an attribute of a markup language, such as HTML, XML or the like, or an element or attribute of a style sheet. Consequently, similarly to extracting the differences in character strings, the difference information may be extracted and generated as the difference in presentation.

In the information processing apparatus 16 of the present exemplary embodiment, display screen information, indicating the display content in which the difference information is reflected, is generated and output to the client device 12. However, the present invention is not limited thereto. In an alternative exemplary embodiment, configuration may be made such that the difference information alone is output to the client device 12, then display content in which the difference information is reflected is generated at the client device 12, and displayed on the screen of the user I/F 22. In the present exemplary embodiment, for example, the information indicating the display content is provided to a user in HTML format. However, XML format is easier to handle than HTML format, when considering storage and manipulation of the information indicating the display content. Therefore, in an information processing apparatus 16 of the alternative exemplary embodiment, configuration may be made such that storage and administration is efficiently made by handling in XML format, and conversion is made to HTML format at the client device 12 just prior to display to a user.

The present exemplary embodiment is configured with the information processing apparatus 16 equipped with the latest display content storage section 60, the display content storage section 62 and the display content administration table storage section 64. However, in an alternative exemplary embodiment, the storage sections may be an external device.

In the present exemplary embodiment, the validity periods of the display content, as shown in FIG. 9, are stored in the display content administration table, and determination of validity period is made using these. However, the present invention is not limited thereto. In an alternative exemplary embodiment, configuration may be made such that, in order to generate the difference information using the difference information generation section 56, when an HTML file of the stored contents that has been stored on the display content storage section 62 is read out, the validity period is extracted from the previously described tag information in the HTML file, and determination is made therefrom.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition section that acquires first display content information indicating display content being displayed at a display section of a device used by a user, and user information indicating the user that displayed the display content at the display section;
a generating section that, when second display content information corresponding to the user information acquired by the acquisition section is stored in a storage section, generates difference information indicating a difference between the stored second display content information and the acquired first display content information being displayed at the display section; and
a transmission section that transmits a display instruction to display the difference information at the display section of the device.

2. The information processing apparatus of claim 1, wherein:
the generating section generates third display content information in which the difference information is reflected in the display content information being displayed at the display section; and
the transmission section transmits a display instruction to the display section to display the third display content information at the display section.

3. The information processing apparatus of claim 1, further comprising a validity period storage section that stores a validity period of the second display content information in the storage section, wherein the generating section does not generate the difference information when the second display content information, associated with the user information acquired by the acquisition section has expired its validity period.

4. The information processing apparatus of claim 3 further comprising a deleting section that deletes the second display content information stored in the storage section when the validity period has expired.

5. An information processing system comprising:
a device including a display section that acquires and displays content instructed by a user, and
an information processing apparatus comprising:
an acquisition section that acquires first display content information indicating display content being displayed at the display section of the device, and user information indicating the user that displayed the display content at the display section;
a generating section that generates difference information indicating a difference between second display content information indicating display content stored in a storage section and the first display content information being displayed at the display section; and
a transmission section that transmits a display instruction to display the difference information at the display section of the device.

6. An information processing method comprising:
acquiring first display content information indicating display content being displayed at a display section of a device used by a user, and user information indicating the user that has displayed the display content at the display section;
generating difference information, when second display content information corresponding to the acquired user information is stored in a storage section, the difference information indicating a difference between the stored second display content information and the first display content information being displayed at the display section; and
transmitting a display instruction to display the difference information at the display section of the device.

7. A computer readable medium storing a program causing a computer to execute information processing, the processing comprising:
acquiring first display content information indicating display content being displayed at a display section of a device used by a user, and user information indicating the user that has displayed the display content at the display section;
generating difference information, when second display content information corresponding to the acquired user information is stored in a storage section, the difference information indicating a difference between the stored second display content information and the first display content information being displayed at the display section; and
transmitting a display instruction to display the difference information at the display section of the device.
